(19) United States
(12) Patent Application Publication
(10) Pub. No.: US 2023/0274343 A1
(43) Pub. Date: Aug. 31, 2023

(54) MANAGEMENT SERVER, AND CONTROL METHOD OF MANAGEMENT SERVER

(71) Applicant: HONDA MOTOR CO., LTD., Tokyo (JP)

(72) Inventor: Kazutaka Nakabe, Wako-shi (JP)

(21) Appl. No.: 18/159,801

(22) Filed: Jan. 26, 2023

(30) Foreign Application Priority Data
Feb. 28, 2022 (JP) 2022-029243

(51) Int. Cl. G06Q 30/0645

(52) U.S. Cl. CPC G06Q 30/0645

(57) ABSTRACT

A management server that manages lending and borrowing of a battery provided in a moving body receives a lending location designated by a lender from first electronic equipment, records the lending location in association with the lender, in a case where a request for borrowing of the battery is received from second electronic equipment, grants permission for borrowing to a borrower by transmitting information necessary for borrowing of the battery at the lending location to the second electronic equipment, and in a case where the borrower who acquires the permission for borrowing cannot borrow the battery at the lending location or in a case where a remaining battery level of the battery is equal to or less than a predetermined value, imposes penalty on the lender of the battery.

### INCORPORATION BY REFERENCE

The present application claims priority under 35 U.S.C. § 119 to Japanese Patent Application No. 2022-029243 filed on Feb. 28, 2022. The content of the applications is incorporated herein by reference in its entirety.

### BACKGROUND OF THE INVENTION

### Field of the Invention

The present invention relates to a management server, and a control method of the management server.

### Description of the Related Art

In recent years, a battery has been used for the purpose of expanding a ratio of renewable energy, because power charged by renewable energy can be used at locations other than a charging location. Further, a technique using a battery has been proposed in related art (see, for example, Japanese Patent No. 6882588). Japanese Patent No. 6882588 discloses an electric vehicle including a body battery attached to a vehicle body, and a drive source outputting driving force for traveling using power of the body battery, the electric vehicle detachably holding a user battery possessed by a user separately from the body battery, a holder having a function of charging the user battery being provided in the vehicle body.

In related art, there is a possible rental system in which a user who possesses a user battery (hereinafter, referred to as a “lender”) lends the user battery to a user of a third party (hereinafter, referred to as a “borrower”).

Further, by this rental system including a mechanism in which the borrower can borrow the user battery by extracting the user battery from a holder of an electric vehicle of the lender, the lender can lend the user battery at a lending location where the lender arrives as a result of moving by the electric vehicle, so that it is possible to improve user-friendliness of the lender.

However, in a case where the borrower goes to the lending location to borrow the user battery, if the borrower cannot borrow the user battery for some reasons, the borrower suffers a disadvantage of wasting time and effort.

The present invention is directed to providing a management server capable of correcting disadvantages that can be suffered by a borrower, and a control method of the management server.

### SUMMARY OF THE INVENTION

One aspect of the present invention is a management server that manages lending and borrowing of a battery between a lender who lends the battery and a borrower who borrows the battery, the battery being detachably provided in a moving body, the management server including: a lending management unit configured to receive a lending location designated by the lender as a location where lending of the battery is to be implemented from first electronic equipment operated by the lender and record the lending location in association with the lender; a borrowing permission granting unit configured to, in a case where a request for borrowing the battery is received from second electronic equipment operated by the borrower, grant permission for borrowing to the borrower by transmitting information necessary for borrowing of the battery at the lending location to the second electronic equipment; and a lending management unit configured to, in a case where the borrower who acquires permission for borrowing cannot borrow the battery at the lending location or in a case where a remaining battery level of the battery is equal to or less than a predetermined value, impose penalty on the lender of the battery.

According to one aspect of the present invention, it is possible to correct disadvantages that can be suffered by a borrower.

### BRIEF DESCRIPTION OF THE DRAWINGS

FIG. 1 is a view illustrating a configuration of a rental system according to an embodiment of the present invention;

FIG. 2 is a view illustrating an aspect where a battery station is attached to a moving body;

FIG. 3 is a view schematically illustrating a configuration of the battery station;

FIG. 4 is a view illustrating a device configuration of first electronic equipment and second electronic equipment;

FIG. 5 is a view illustrating a functional configuration of a management server;

FIG. 6 is a view illustrating a functional configuration of processors of the first electronic equipment and the second electronic equipment;

FIG. 7 is a view illustrating an example of a display aspect of a search result;

FIG. 8 is a view illustrating a functional configuration of a control device of the battery station;

FIG. 9 is a view illustrating operation of the rental system in a case where a borrower borrows a power pack;

FIG. 10 is a view illustrating operation of the rental system in a case where the borrower evaluates a lender; and

FIG. 11 is a view illustrating operation of the rental system in a case where the lender implements lending of the power pack.

### DETAILED DESCRIPTION OF THE PREFERRED EMBODIMENTS

An embodiment of the present invention will be described below with reference to the drawings.

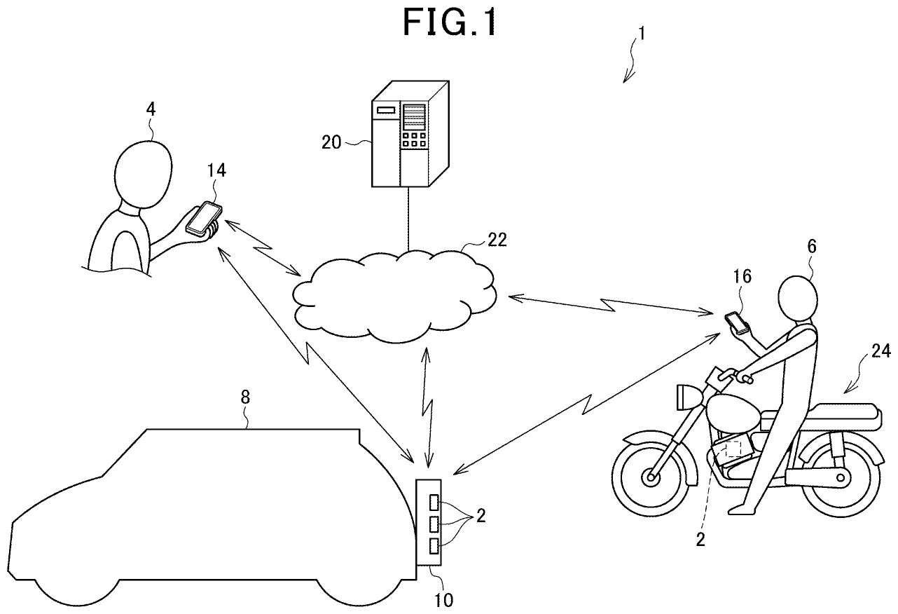

FIG. 1 is a view illustrating a configuration of a rental system 1 according to the present embodiment.

The rental system 1 is a system that provides a lending and borrowing service of a power pack 2 between a lender 4 who lends the power pack 2 that is a portable battery and a borrower 6 who borrows the power pack 2. As illustrated in FIG. 1, the rental system 1 of the present embodiment includes a battery station 10 that is provided in a moving body 8 operated by the lender 4, the battery station 10 detachably holding the power pack 2, first electronic equipment 14 operated by the lender 4, second electronic equipment 16 operated by the borrower 6, an electric vehicle 24 which is one example of equipment for which the power pack 2 borrowed by the borrower 6 is to be utilized, and a management server 20 that manages lending and borrowing of the power pack 2, and each of the battery station 10, the first electronic equipment 14, the second electronic equipment 16, the electric vehicle 24 and the management server 20 is connected to a communication network 22 such as the Internet so as to be able to perform communication.

The lender 4, who has right to lend the power pack 2 to a third party, is, for example, an owner of the power pack 2 or a person who has right to sublease the power pack 2 borrowed from a business operator of the rental system 1. The lender 4 of the present embodiment also has property right or right of use of the moving body 8.

The moving body 8, which is an object that moves on the ground, in the air, at sea or under water along with the battery station 10 by operation by the lender 4, for example, includes a vehicle, an air vehicle, a ship, and the like. In the present embodiment, an electric four-wheeled vehicle which is one aspect of the vehicle will be described as an example of the moving body 8.

The power pack 2 is a portable battery that is detachably provided in the moving body 8 by being detachably held by the battery station 10 and includes any type (material of electrodes) of battery.

The borrower 6 refers to a person who has right to use the power pack 2 by borrowing the power pack 2 from the lender 4. The borrower 6 of the present embodiment is a user of the electric vehicle 24.

The electric vehicle 24 is a vehicle such as a two-wheeled vehicle, a three-wheeled vehicle, a four-wheeled vehicle, or the like, including the power pack 2 provided so as to be freely exchangeable, and a motor that outputs driving force for driving a drive wheel of a vehicle body by power of the power pack 2.

The management server 20, which is a server computer that provides the lending and borrowing service, manages lending and borrowing of the power pack 2 between the lender 4 and the borrower 6.

The first electronic equipment 14 and the second electronic equipment 16 are both equipment corresponding to a client computer that receives provision of the lending and borrowing service from the management server 20. In other words, the first electronic equipment 14 executes processing related to lending of the power pack 2 with respect to the management server 20 on the basis of operation by the lender 4, and the second electronic equipment 16 executes processing related to borrowing of the power pack 2 with respect to the management server 20 on the basis of operation by the borrower 6.

The first electronic equipment 14 and the second electronic equipment 16 are, for example, portable electronic equipment such as a smartphone and a notebook personal computer or stationary electronic equipment such as a desktop personal computer.

Here, the lending and borrowing service in the rental system 1 of the present embodiment assumes the following first to fourth items.

The first item is that the lender 4 lends the power pack 2 at a current location of the moving body 8 as a lending location.

The second item is that when the borrower 6 borrows the power pack 2, the borrower 6 exchanges the borrowed power pack 2 for the power pack 2 that is being used in the electric vehicle 24 (so-called exchange method).

The third item is that in a case where the power pack 2 is exchanged by the borrower 6, the lender 4 can lend the power pack 2 acquired through exchange. In other words, the lender 4 has right to sublease the power pack 2 acquired through exchange.

The fourth item is that the lender 4 can receive an incentive in accordance with a lending record of the power pack 2 from a business operator of the rental system 1, or the like.

According to such a rental system 1, the lender 4 can lend the power pack 2 also at a location (such as, for example, a shopping mall) where the lender 4 arrives by moving by the moving body 8 as well as home of the lender 4. Further, the lender 4 can receive an incentive by repeatedly lending the power pack 2 without the number of times of lending being limited to a quantity of stock.

On the other hand, in a case where a remaining battery level of the power pack 2 of the electric vehicle 24 becomes less, the borrower 6 can borrow the power pack 2 from the lender 4 who lends the power pack 2 around the borrower 6 and can exchange the power pack 2 for the power pack 2 of the electric vehicle 24. This can solve a problem of shortage of the remaining battery level by exchanging the power pack 2 borrowed from the lender 4 for the power pack 2 even in a case where the remaining battery level of the power pack 2 becomes insufficient when the borrower 6 is travelling by the electric vehicle 24 in a region where facilities for charging are not sufficiently provided.

A configuration of each unit of the rental system 1 will be described in detail next.

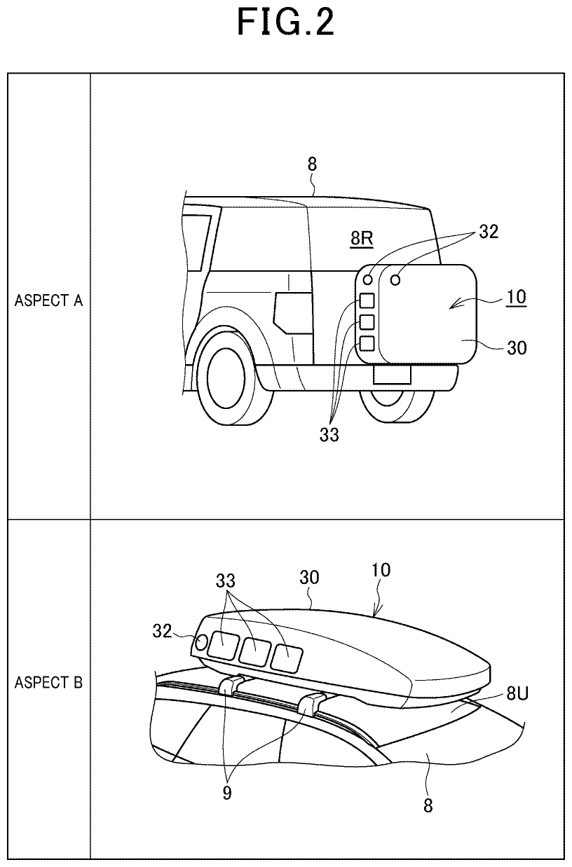

FIG. 2 is a view illustrating an aspect where the battery station 10 is attached to the moving body 8.

As described above, the moving body 8 of the present embodiment is an electric four-wheeled vehicle, and an aspect where the battery station 10 is attached to the moving body 8 includes an aspect A and an aspect B illustrated in FIG. 2. The aspect A is an aspect where the battery station 10 is provided at a location where a spare tire (so-called rear surface tire) is fixed on a rear surface 8R of the vehicle body of the moving body 8. The aspect B is an aspect where the battery station 10 is fixed at a roof carrier 9 provided on a roof 8U of the vehicle body of the moving body 8 in place of a roof box. A size, a shape and appearance of the battery station 10 are different for each of the aspect A and the aspect B, and the battery station 10 in the aspect A has a box shape having a size corresponding to the spare tire, and the battery station 10 in the aspect B has an external shape similar to an external shape of the roof box.

In either the aspect A or the aspect B, the battery station 10 is provided at a position outside the vehicle body of the moving body 8, so that the borrower 6 can visually confirm the battery station 10 and the borrower 6 can easily extract the power pack 2.

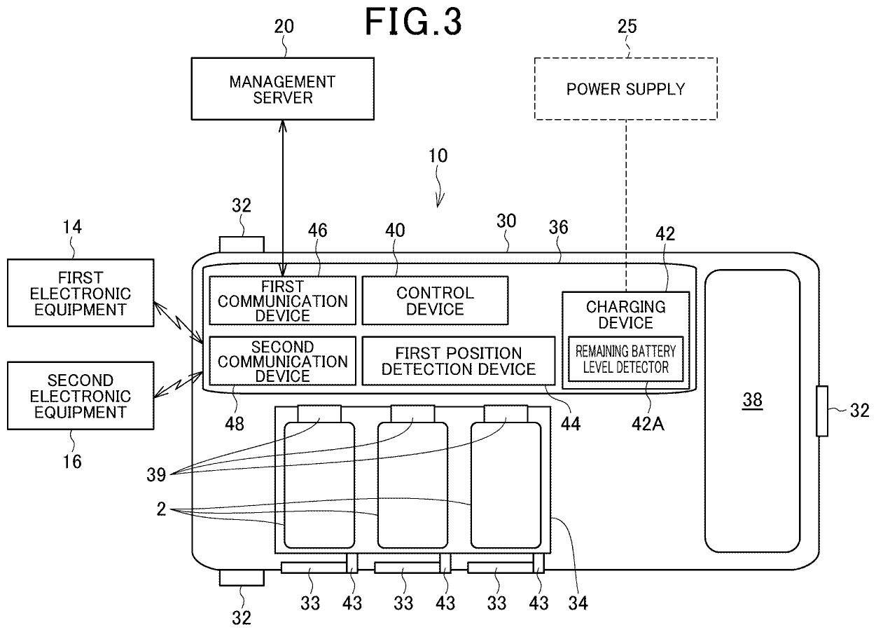

FIG. 3 is a view schematically illustrating a configuration of the battery station 10. Note that FIG. 3 is merely a schematic view and does not indicate accurate layout, shapes and sizes of the respective units.

The battery station 10 includes a chassis 30 that stores a plurality of (three in the illustrated example) power packs 2, and a plurality of (three in the illustrated example) displays 32 provided so as to be able to be visually confirmed from outside of the chassis 30. Inside of the chassis 30, a holding unit 34 that detachably holds the power packs 2, an electrical unit 36 that stores various kinds of electric/electronic circuits, a storage space 38 in which the lender 4 (that is, the user of the moving body 8) can store baggage are provided. Further, in the electrical unit 36, a control device 40, a charging device 42, a first position detection device 44, a first communication device 46 and a second communication device 48 are stored.

The display 32 is equipment indicating whether or not the state is in a state where the borrower 6 can borrow the power pack 2 (that is, whether or not lending of the power pack 2 is being implemented), and, for example, a display lamp, a flat panel display, or the like, is used. The borrower 6 can easily find the battery station 10 (moving body 8) that is implementing lending at that time point with help from display of the display 36.

In the present embodiment, the displays 32 are respectively provided at a position corresponding to a rear surface of the moving body 8 and positions corresponding to right and left side surfaces of the moving body 8, so that the borrower 6 can visually confirm the displays 32 in any direction of three surfaces of the rear surface, and the right and left side surfaces. This can reduce occurrence of a situation where display of the display 32 is hidden by an object around the moving body 8, and the borrower 6 cannot visually confirm the display and cannot find the power pack 2 that is a lending target.

The holding unit 34 includes a charging connector 39 that is electrically connected to electrodes of the power packs 2, and a lock mechanism 43 that makes it impossible to extract the power pack 2 in accordance with an instruction from the control device 40. The lock mechanism 43 includes, for example, an electric key that locks a cover body 33 of a power pack slot formed in the chassis 30 to make it impossible to open and close the cover body 33, or an electric control latching mechanism that catches the power pack 2 stored in the chassis 30 and makes it impossible to extract the power pack 2 as a mechanism that makes it impossible to extract the power pack 2.

The control device 40, which is a device that controls the respective units of the battery station 10, includes a computer including a processor such as a central processing unit (CPU) and a micro-processing unit (MPU), a memory device (also referred to as a primary storage device) such as a read only memory (ROM) and a random access memory (RAM), a storage device (also referred to as a secondary storage device) such as a solid state drive (SSD), and an interface circuit for connecting other devices and sensors. Further, by the processor executing a computer program stored in the memory device or the storage device, various kinds of functions of the battery station 10 are implemented. A functional configuration of the control device 40 will be described later. Note that the control device 40 may include a plurality of computers, and the computers may implement various kinds of functions in cooperation with each other.

The charging device 42, which is a device that charges the power pack 2 using power supplied from a power supply 25 as appropriate, includes a remaining battery level detector 42A (sensor) that detects the remaining battery level of the power pack 2. The power supply 25 is, for example, a commercial power supply or a charging facility. Note that the power supply 25 may be a stationary in-vehicle battery mounted on the moving body 8. Further, the charging device 42 may charge the power pack 2 using power branching from power for charging when the in-vehicle battery of the moving body 8 is charged.

The lender 4 can lend the power pack 2 after putting the power pack 2 into a fully charged condition in advance by causing the charging device 42 to operate. Note that the charging device 42 may automatically charge the respective power packs 2 held in the holding unit 34 while power is supplied from the power supply 25 and may maintain the power packs 2 in a fully charged condition.

The first position detection device 44, which is a device that detects a position of the battery station 10, includes a global navigation satellite system (GNSS) receiver that receives positioning signals emitted from a plurality of positioning satellites.

The first communication device 46 is a device including a transmitter and a receiver that transmits/receives data to/from the management server 20. Note that in a case where the moving body 8 includes a communication device that performs communication with the management server 20 through the communication network 22 and a telematics control unit (TCU), the first communication device 46 may perform communication with the management server 20 by way of the TCU.

The second communication device 48 is a device including a transmitter and a receiver that transmits/receives data to/from each of the first electronic equipment 14 and the second electronic equipment 16.

In the present embodiment, the second communication device 48, the first electronic equipment 14 and the second electronic equipment 16 transmit/receive data by performing communication using a near field communication scheme. In other words, only in a case where the lender 4 who operates the first electronic equipment 14 and the borrower 6 who operates the second electronic equipment 16 are located near the battery station 10 that is a communication target (within a communication range of the second communication device 48), the first electronic equipment 14 and the second electronic equipment 16 can perform communication with the second communication device 48. Note that any communication protocol may be used in the near field communication scheme.

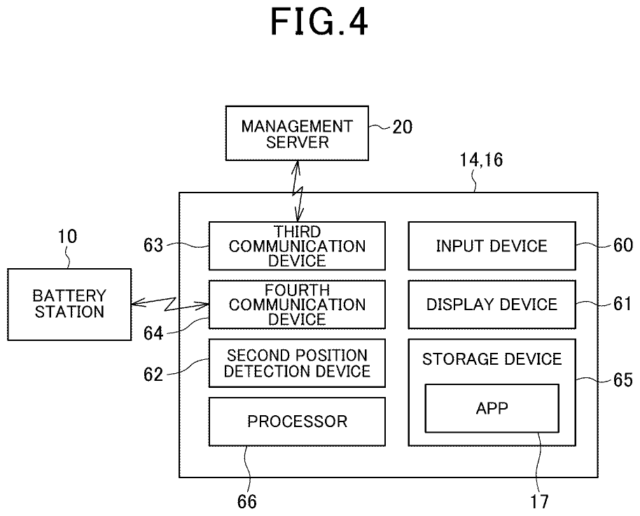

FIG. 4 is a view illustrating a device configuration of the first electronic equipment 14 and the second electronic equipment 16.

Both the first electronic equipment 14 and the second electronic equipment 16 include an input device 60, a display device 61, a second position detection device 62, a third communication device 63, a fourth communication device 64, a storage device 65 and a processor 66.

The input device 60, which is a device that accepts operation input by a user such as the lender 4 and the borrower 6, includes, for example, a touch panel and an operation button.

The display device 61, which is a device that displays various kinds of information, includes, for example, a flat panel display.

The second position detection device 62, which is a device that detects a current position, includes a GNSS receiver in a similar manner to the first position detection device 44 described above. Note that in a case where the first electronic equipment 14 and the second electronic equipment 16 are equipment that performs communication with a mobile phone communication network, the second position detection device 62 may detect a current position on the basis of position information of a base station included in the mobile phone communication network.

The third communication device 63 is a device including a transmitter and a receiver that transmits/receives data to/from the management server 20 via the communication network 22.

The fourth communication device 64, which is a device including a transmitter and a receiver that transmits/receives data to/from the second communication device 48 included in the battery station 10, is a near field communication device that performs communication using the near field communication scheme in the present embodiment.

The storage device 65 is a device that stores an app 17. The app 17 is a computer program (application program) that causes the first electronic equipment 14 and the second electronic equipment 16 to operate as a client computer that receives the lending and borrowing service of the power pack 2 from the management server 20.

The processor 66, which is an arithmetic circuit such as a CPU and an MPU, implements various kinds of functions by executing the app 17. Note that functional configurations to be implemented by execution of the app 17 will be described later.

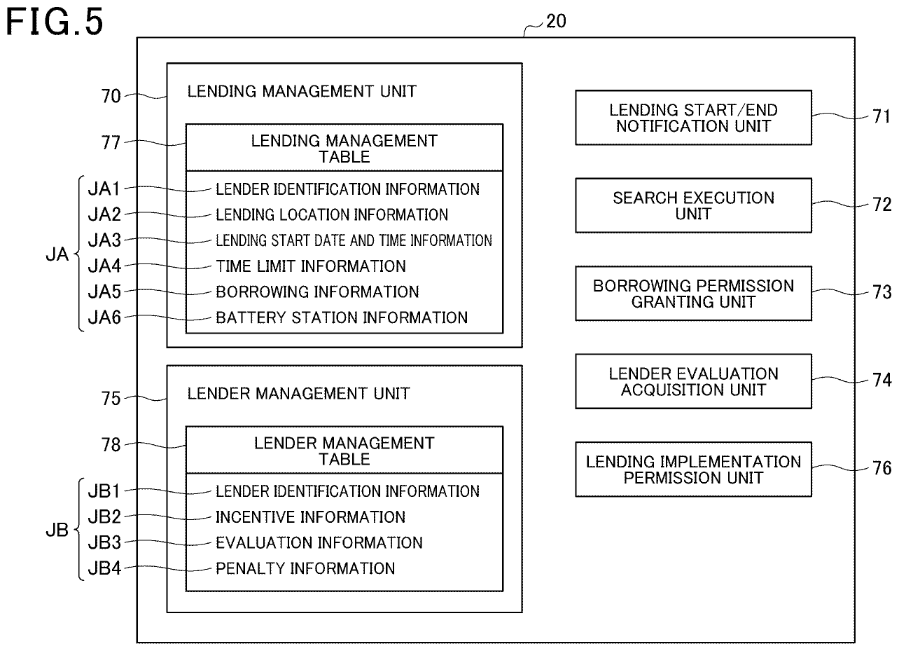

FIG. 5 is a view illustrating a functional configuration of the management server 20.

The management server 20 is a computer including a processor such as a CPU and an MPU, a memory device such as a ROM and a RAM, a storage device such as an SSD, and a communication device including a transmitter and a receiver that transmits/receives data to/from other computers through the communication network 22.

Further, by the processor executing the computer program stored in the memory device or the storage device, various kinds of functional configurations illustrated in FIG. 5 are implemented. Note that the management server 20 may include a plurality of computers, and the computers may implement the functional configurations illustrated in FIG. 5 in cooperation with each other.

As illustrated in FIG. 5, the management server 20 includes a lending management unit 70, a lending start/end notification unit 71, a search execution unit 72, a borrowing permission granting unit 73, a lender evaluation acquisition unit 74, a lender management unit 75, and a lending implementation permission unit 76.

The lending management unit 70 manages implementation of lending of the power pack 2 by the lender 4 and stores a lending management table 77 that records information related to implementation of lending (hereinafter, referred to as “lending implementation information JA”).

The lending implementation information JA includes lender identification information JA1, lending location information JA2, lending start date and time information JA3, time limit information JA4, borrowing information JA5, and battery station information JA6, which are recorded in association with each other in the lending management table 77 by the lending management unit 70.

The lender identification information JA1 is information that uniquely identifies the lender 4.

The lending location information JA2 is information indicating a lending location (that is, a location where the moving body 8 to which the battery station 10 is attached is located) where the lender 4 implements lending of the power pack 2.

The lending start date and time information JA3 is information indicating lending start date and time at which lending of the power pack 2 is started at the lending location.

The time limit information JA4 is information indicating a time limit that limits a time period during which the borrower 6 can borrow the power pack 2 at the lending location. In other words, the time limit is a maximum time period during which the lender 4 lends the power pack 2 at the lending location. By providing such time limit, when the time limit has elapsed, the lender 4 can move from the lending location regardless of whether or not there is the borrower 6, so that the lender 4 does not have to endlessly wait for the borrower 6.

The borrowing information JA5 is information necessary for the borrower 6 to borrow the power pack 2 from the battery station 10, and in the present embodiment, is an unlock code for unlocking the lock mechanism 43 of the battery station 10.

The battery station information JA6, which is information related to the battery station 10 provided in the moving body 8 of the lender 4, includes information (such as a network address) necessary for the battery station 10 and the management server 20 to perform communication.

In the present embodiment, such lending implementation information JA is set by the lender 4 operating the first electronic equipment 14 and transmitted from the first electronic equipment 14 to the management server 20. Note that among the lending implementation information JA, some pieces of information such as information related to the battery station 10 may be registered in the management server 20 in advance.

The lending start/end notification unit 71 notifies the battery station 10 of a timing of start of implementation of lending and a timing of end of implementation of lending. The timing of start of implementation of lending is lending start date and time indicated by the lending start date and time information JA3, and the timing of end of implementation of lending is a timing at which the time limit indicated by the time limit information JA4 has elapsed from the lending start date and time.

The lending start/end notification unit 71 makes a notification by transmitting a transmission message indicating the timing of start of implementation of lending and the timing of end of implementation of lending to the battery station 10. The battery station 10 displays whether or not the state is a state where the borrower 6 can borrow the power pack 2 by controlling display of the display 32 described above in accordance with this notification.

The search execution unit 72 searches the lending implementation information JA recorded in the lending management table 77 for lending that is being implemented around the second electronic equipment 16 operated by the borrower 6 and transmits information related to the lending to the second electronic equipment 16 as a search result.

In the present embodiment, the search execution unit 72 transmits the lending location information JA2, the lending start date and time information JA3 and the time limit information JA4 among the lending implementation information JA as the search result.

The borrowing permission granting unit 73 is a functional unit that grants the borrower 6 permission for borrowing the power pack 2 from the battery station 10 of the lender 4, and in the present embodiment, the borrowing permission granting unit 73 grants the borrower 6 permission for borrowing by transmitting the borrowing information JA5 to the second electronic equipment 16 of the borrower 6.

The lender evaluation acquisition unit 74 acquires evaluation on the lender 4 by the borrower 6. Any aspect of evaluation may be employed if the evaluation can be converted into scores, and examples of the evaluation can include step evaluation with respect to a plurality of evaluation items set in advance.

Further, the lender evaluation acquisition unit 74 in the present embodiment accepts evaluation only in a case where predetermined conditions are satisfied. The predetermined conditions include that an evaluation result is evaluation on the lender 4 corresponding to lending for which permission for borrowing is acquired, and that the borrower 6 performs evaluation at the lending location. By accepting evaluation only in a case where such predetermined conditions are satisfied, only evaluation with high credibility can be collected.

The lender management unit 75 is a functional unit that manages information regarding the lender 4 and in the present embodiment, stores a lender management table 78 that records information related to the lender 4 (hereinafter, referred to as “lender information JB”).

One piece of lender information JB includes lender identification information JB1, incentive information JB2, evaluation information JB3 and penalty information JB4, which are recorded in association with each other in the lender management table 78 by the lender management unit 75.

The lender identification information JB1, which is information that uniquely identifies the lender 4, corresponds to the lender identification information JA1 in the lending management table 77 described above.

The incentive information JB2 is information of incentive to be provided to the lender 4. In the incentive information JB2, information on incentive having value in accordance with a lending record of the power pack 2 (such as the number of power packs 2 that have been actually lent) is recorded. Note that any specific aspect of the incentive may be employed, and, examples of the incentive can include a discount ticket, a cash voucher, a gift, and the like.

The evaluation information JB3 is information related to evaluation on the lender 4 by the borrower 6 and in the present embodiment, includes an evaluation value obtained by quantifying evaluation by the borrower 6 acquired by the lender evaluation acquisition unit 74 to enable comparison of evaluation.

The penalty information JB4 is information of penalty to be imposed on the lender 4. In the penalty information JB4, information on penalty in accordance with evaluation (that is, the evaluation information JB3) on the lender 4 by the borrower 6 is recorded. In the present embodiment, one of the penalty to be imposed on the lender 4 includes at least restriction (including prohibition) of implementation of lending by the lender 4.

The lending implementation permission unit 76 determines whether or not to permit implementation of lending for the lender 4 who applies for the implementation of lending on the basis of the penalty information JB4, and in a case where the lending implementation permission unit 76 determines to “permit”, the lending management unit 70 records the lending implementation information JA in the lending management table 77, and in a case where the lending implementation permission unit 76 determines “not to permit”, the lending management unit 70 rejects the application for the implementation of lending without recording the lending implementation information JA in the lending management table 77.

This can exclude implementation of lending by the lender 4 who has low evaluation by the borrower 6 and can reduce situations where the borrower 6 suffers disadvantages.

Further, in addition to evaluation on the lender 4, the lending implementation permission unit 76 in the present embodiment uses whether or not the moving body 8 is stopped when an application for implementation of lending is transmitted from the first electronic equipment 14 of the lender 4, conformity of current positions of the first electronic equipment 14 and the battery station 10 at that time, and the remaining battery level of the power pack 2 at that time as determination conditions as to whether or not to permit implementation of lending. In a case where an application for implementation of lending is received, the lending implementation permission unit 76 acquires information on the current position and the remaining battery level from the battery station 10 by transmitting an inquiry message for inquiring about these kinds of information to the battery station 10 via the communication network 22.

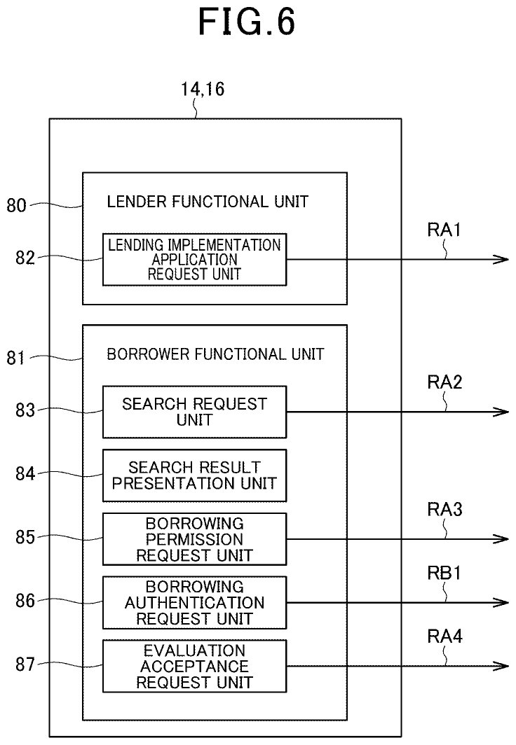

FIG. 6 is a view illustrating a functional configuration of the first electronic equipment 14 and the second electronic equipment 16.

As illustrated in FIG. 6, the first electronic equipment 14 and the second electronic equipment 16 function as a lender functional unit 80 and a borrower functional unit 81 by execution of the app 17.

The lender functional unit 80, which is a functional unit that provides functions related to lending of the power pack 2 to the lender 4, includes a lending implementation application request unit 82.

The lending implementation application request unit 82 transmits a lending implementation application request RA1 to the management server 20 in response to operation by the lender 4. The lending implementation application request RA1 is a transmission message for applying for implementation of lending of the power pack 2 by the lender 4. Further, the lending implementation application request unit 82 transmits information included in the lending implementation information JA described above to the management server 20 by including the information in the lending implementation application request RA1 or after transmitting the lending implementation application request RA1. The borrowing information JA5 to be included in the lending implementation information JA may be designated by the lender 4 or may be generated by the management server 20.

The borrower functional unit 81, which is a functional unit that provides functions related to borrowing of the power pack 2 to the borrower 6, includes a search request unit 83, a search result presentation unit 84, a borrowing permission request unit 85, a borrowing authentication request unit 86 and an evaluation acceptance request unit 87.

The search request unit 83 transmits a search request RA2 to the management server 20 in response to operation by the borrower 6. The search request RA2 is a transmission message for requesting execution of search for lending that is being implemented around the current position of the second electronic equipment 16.

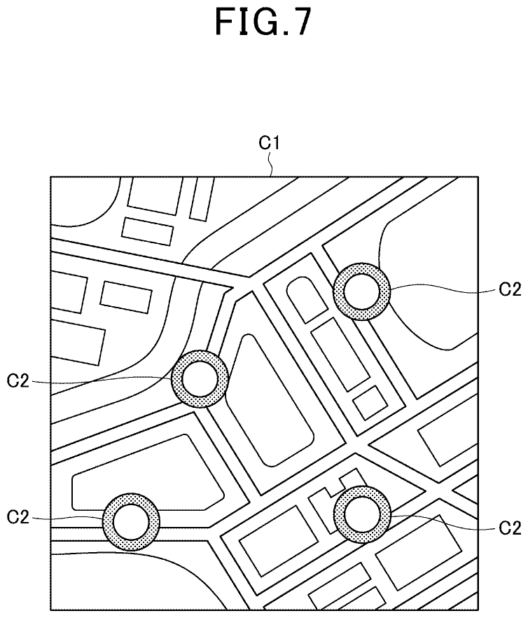

The search result presentation unit 84 is a functional unit that presents a search result received from the management server 20 to the borrower 6 as a response message to the search request RA2. As illustrated in FIG. 7, the search result presentation unit 84 in the present embodiment displays lending icons C2 at positions indicated by the lending location information JA2 included in the search result on a map C1 around the current position. While not illustrated, the lending icon C2 includes display of lending start date and time and time limit, so that the borrower 6 can select desired lending in view of a distance from the current position of the borrower 6, the time limit, and the like, on the basis of the display.

The borrowing permission request unit 85 transmits a borrowing permission request RA3 to the management server 20 in response to operation by the borrower 6. The borrowing permission request RA3 is a transmission message for requesting permission of borrowing for the power pack 2 to be lent at the lending location selected by the borrower 6. Further, the borrowing permission request unit 85 receives the borrowing information JA5 described above from the management server 20 as a response message to the borrowing permission request RA3, and as a result, permission for borrowing is granted to the borrower 6 from the management server 20.

The borrowing authentication request unit 86 transmits an unlock request RB1 to the battery station 10 through near field communication in response to operation by the borrower 6. The unlock request RB1 is a transmission message for requesting unlocking of the lock mechanism 43 described above to the battery station 10. Further, the borrowing authentication request unit 86 transmits the borrowing information JA5 described above to the battery station 10 through near field communication by including the borrowing information JA5 in the unlock request RB1 or after transmitting the unlock request RB1.

The evaluation acceptance request unit 87 transmits an evaluation acceptance request RA4 to the management server 20 in response to operation by the borrower 6. The evaluation acceptance request RA4 is a transmission message for requesting acceptance of evaluation on the lender 4 by the borrower 6.

Note that the lender functional unit 80 and the borrower functional unit 81 may be respectively implemented in different apps. In this case, the first electronic equipment 14 executes an app in which the lender functional unit 80 is implemented, and the second electronic equipment 16 executes an app in which the borrower functional unit 81 is implemented.

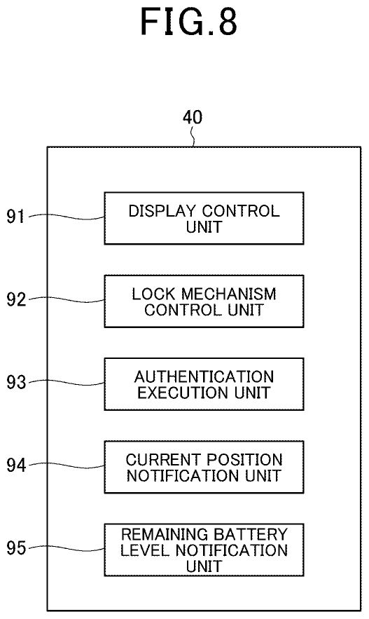

FIG. 8 is a view illustrating a functional configuration of the control device 40 of the battery station 10.

As illustrated in FIG. 8, the control device 40 includes a display control unit 91, a lock mechanism control unit 92, an authentication execution unit 93, a current position notification unit 94, and a remaining battery level notification unit 95.

The display control unit 91 controls display on the display 32 on the basis of the timing of start of implementation of lending described above and a timing of end of implementation of lending notified from the management server 20.

The lock mechanism control unit 92 controls locking and unlocking of the lock mechanism 43.

The authentication execution unit 93 authenticates permission for borrowing by the borrower 6 on the basis of the borrowing information JA5 transmitted by the second electronic equipment 16 in a case where the unlock request RB1 described above is received from the second electronic equipment 16 through near field communication, and, in a case where permission for borrowing is valid, causes the lock mechanism control unit 92 to unlock the lock mechanism 43 so as to allow the borrower 6 to extract the power pack 2 from the battery station 10. Such authentication is performed through collation between the borrowing information JA5 transmitted by the second electronic equipment 16 and the borrowing information JA5 recorded in the management server 20.

The current position notification unit 94 is a functional unit that notifies the management server 20 of the current position of the battery station 10 in response to an inquiry from the management server 20, and the remaining battery level notification unit 95 is a functional unit that notifies the management server 20 of the remaining battery level of the power pack 2 stored in the battery station 10 in response to an inquiry from the management server 20.

Operation of the rental system 1 will be described next.

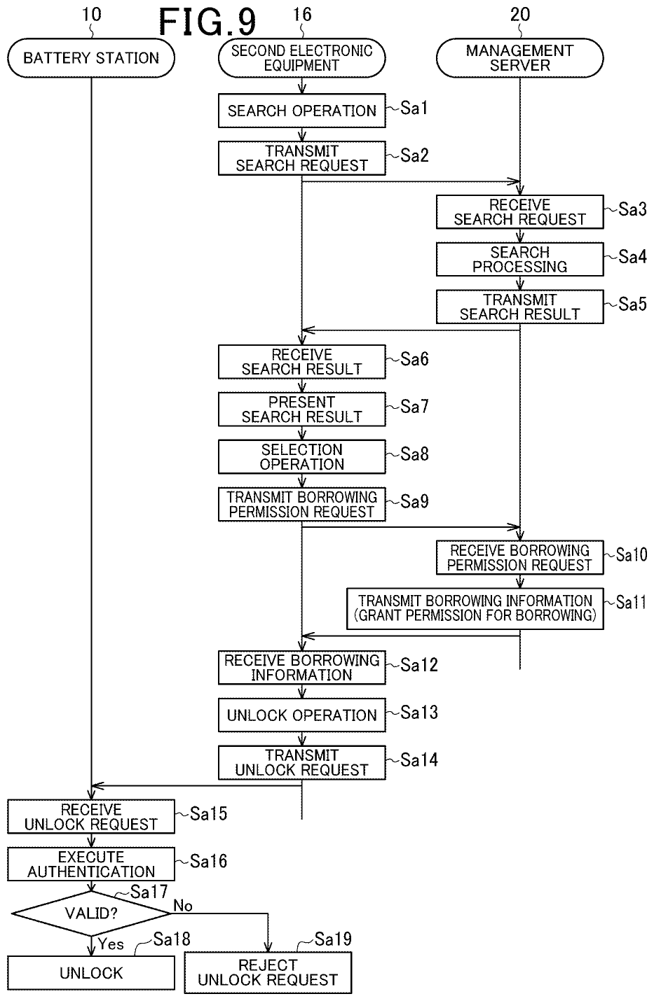

FIG. 9 is a view illustrating operation of the rental system 1 in a case where the borrower 6 borrows the power pack 2.

In a case where the borrower 6 desires to borrow the power pack 2 with a sufficient remaining battery level because the remaining battery level of the power pack 2 mounted on the electric vehicle 24 becomes less while the electric vehicle 24 is traveling, the borrower 6 performs operation (search operation) of searching for a lending location at which lending is being implemented around the second electronic equipment 16, on the second electronic equipment 16.

As illustrated in FIG. 9, in a case where the search operation is performed on the second electronic equipment 16 (step Sa1), the search request unit 83 transmits the search request RA2 and the current position of the second electronic equipment 16 to the management server 20 (step Sa2).

At the management server 20, in a case where the search request RA2 is received (step Sa3), the search execution unit 72 extracts the lending implementation information JA related to lending that is being implemented around the second electronic equipment 16 (a distance falls within a predetermined range) or lending to be implemented hereafter from the lending management table 77 on the basis of the current position of the second electronic equipment 16 and the lending location information JA2 of the lending implementation information JA recorded in the lending management table 77 (step Sa4: search processing). Then, the search execution unit 72 transmits a search result including the lending location information JA2, the lending start date and time information JA3 and the time limit information JA4 of the extracted lending implementation information JA to the second electronic equipment 16 as a response message to the search request RA2 (step Sa5).

In a case where the second electronic equipment 16 receives the search result from the management server 20 (step Sa6), the search result presentation unit 84 presents the search result to the borrower 6 by displaying the above-described lending icons C2 (FIG. 7) indicating the lending locations, lending start date and time, and time limit on the map C1 around the current position in a superimposed manner (step Sa7).

Then, the borrower 6 performs operation (selection operation) of selecting one desired lending icon C2 from the lending icons C2, on the second electronic equipment 16.

In a case where the selection operation is performed on the second electronic equipment 16 (step Sa8), the borrowing permission request unit 85 transmits the above-described borrowing permission request RA3 for requesting permission for borrowing of the power pack 2 at the lending location associated with the lending icon C2 selected through the selection operation to the management server 20 (step Sa9).

In a case where the management server 20 receives the borrowing permission request RA3 (step Sa10), the borrowing permission granting unit 73 reads out the borrowing information JA5 corresponding to permission for borrowing requested by the borrowing permission request RA3 from the lending management table 77 and transmits the borrowing information JA5 to the second electronic equipment 16 (step Sa11), and the second electronic equipment 16 receives the borrowing information JA5 (step Sa12). Permission for borrowing is granted to the borrower 6 from the management server 20 through transmission and reception of the borrowing information JA5.

Then, the borrower 6 moves to the lending location by the electric vehicle 24 and finds the battery station 10 that is implementing lending with the help of display on the display 32 at the location. As described above, the displays 32 are respectively provided on the rear surface and right and left side surfaces of the battery station 10 and can be visually confirmed from at least three directions, so that the borrower 6 can easily find the battery station 10 that is implementing lending.

Then, the borrower 6 comes closer to the battery station 10 and performs operation (unlock operation) of unlocking the lock mechanism 43 of the battery station 10 on the second electronic equipment 16.

In a case where the unlock operation is performed on the second electronic equipment 16 (step Sa13), the borrowing authentication request unit 86 transmits the above-described unlock request RB1 and the borrowing information JA5 to the battery station 10 through near field communication (step Sa14).

In a case where the battery station 10 receives the unlock request RB1 (step Sa15), the authentication execution unit 93 authenticates permission for borrowing by the borrower 6 on the basis of the borrowing information JA5 (step Sa16). Then, in a case where the permission for borrowing is valid (step Sa17: Yes), the authentication execution unit 93 causes the lock mechanism control unit 92 to unlock the lock mechanism 43 (step Sa18: unlock). On the other hand, in a case where the permission for borrowing is not valid (step Sa16: No), the authentication execution unit 93 rejects the request for unlocking with respect to the unlock request RB1 (step Sa19).

Then, if the lock mechanism 43 is unlocked, the borrower 6 exchanges the power pack 2 by extracting the power pack 2 from the battery station 10 and storing the power pack 2 that is being used at the electric vehicle 24 by the borrower 6 in the battery station 10. As a result of this, borrowing by the borrower 6 is completed.

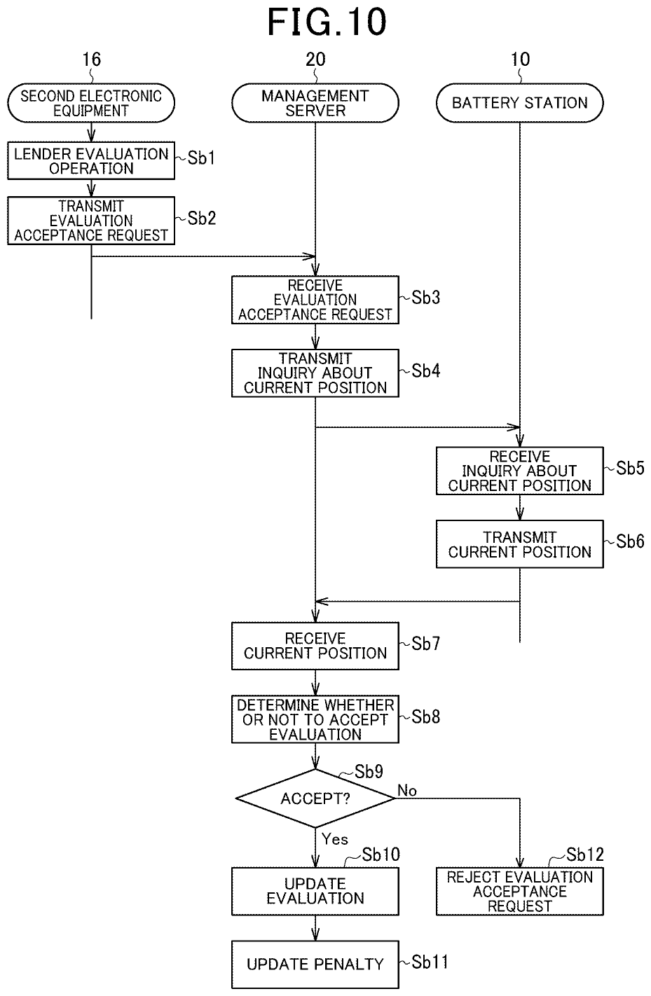

FIG. 10 is a view illustrating operation of the rental system 1 in a case where the borrower 6 evaluates the lender 4.

In the rental system 1, in a case where the borrower 6 cannot borrow the power pack 2 due to a fault of the lender 4 even if the borrower 6 goes to the lending location, the borrower 6 can evaluate the lender 4.

Examples of the fault of the lender 4 can include a case where the lender 4 moves the moving body 8 from the lending location to other locations before the time limit has elapsed, a case where the lender 4 parks the moving body 8 in a garage, or the like, where the borrower 6 cannot enter, a case where the lender 4 parks the moving body 8 near an obstacle (such as, for example, a building and a tree) that can make it difficult to extract the power pack 2, a case where remaining battery levels of all the power packs 2 stored in the battery station 10 are not sufficient, and the like.

In a case where the borrower 6 cannot borrow the power pack 2 due to a fault of the lender 4, the borrower 6 performs operation (lender evaluation operation) of evaluating the lender 4 on the basis of the fault, on the second electronic equipment 16.

As illustrated in FIG. 10, in a case where the lender evaluation operation is performed on the second electronic equipment 16 (step Sb1), the evaluation acceptance request unit 87 transmits an evaluation acceptance request RA4, an evaluation result on the lender 4 by the borrower 6, and the current position to the management server 20 (step Sb2).

In a case where the evaluation acceptance request RA4 is received (step Sb3), the lender evaluation acquisition unit 74 first transmits a transmission message for inquiring about the current position to the battery station 10 (step Sb4). In a case where the inquiry about the current position is received (step Sb5), the battery station 10 transmits the current position to the management server 20 (step Sb6).

In a case where the management server 20 receives the current position of the battery station 10 (step Sb7), the lender evaluation acquisition unit 74 determines whether or not to accept the evaluation result by the borrower 6 received in step Sb3 on the basis of whether or not predetermined conditions are satisfied (step Sb8: evaluation acceptance determination). The predetermined conditions in the present embodiment include that the evaluation result is evaluation on the lender 4 corresponding to the lending for which permission for borrowing is acquired, and that the borrower 6 performs evaluation at the lending location.

The lender evaluation acquisition unit 74 determines to accept the evaluation result only in a case where all the predetermined conditions are satisfied (step S9: Yes) and updates the evaluation information JB3 in the lender management table 78 on the basis of the evaluation result (step Sb10). The updating of the evaluation information JB3 is, for example, performed by adding an evaluation value based on the evaluation result.

Then, the lender management unit 75 determines penalty in accordance with evaluation on the lender 4 on the basis of the evaluation information JB3 and updates the penalty information JB4 in the lender management table 78 by information on the penalty (step Sb11). In the present embodiment, the penalty includes restriction on implementation of lending (including prohibition of implementation of lending) as described above, and the lender management unit 75 imposes the restriction or prohibition of implementation of lending on the lender 4 as the penalty on the basis of a degree or a frequency of faults.

By this means, in a case where a situation occurs where the borrower 6 cannot borrow the power pack 2 due to a fault of the lender 4, the fault committed by the lender 4 is managed in the management server 20 by the situation being reflected in the evaluation on the lender 4. Further, implementation of lending by the lender 4 is restricted in accordance with a degree or a frequency of faults, so that it is possible to reduce occurrence of a situation where the borrower 6 suffers disadvantages due to a fault of the lender 4.

Note that the lender management unit 75 may include a process of reducing or releasing penalty imposed on the lender 4 on the basis of a predetermined rule.

On the other hand, in a case where one of the predetermined conditions is satisfied, the lender evaluation acquisition unit 74 determines not to accept the evaluation result (step Sb9: No) and rejects the evaluation acceptance request RA4 from the second electronic equipment 16 (step Sb12).

In this manner, by reflecting the evaluation result by the borrower 6 in the evaluation information JB3 of the lender 4 only in a case where the predetermined conditions are satisfied, it is possible to improve credibility of evaluation on the lender 4.

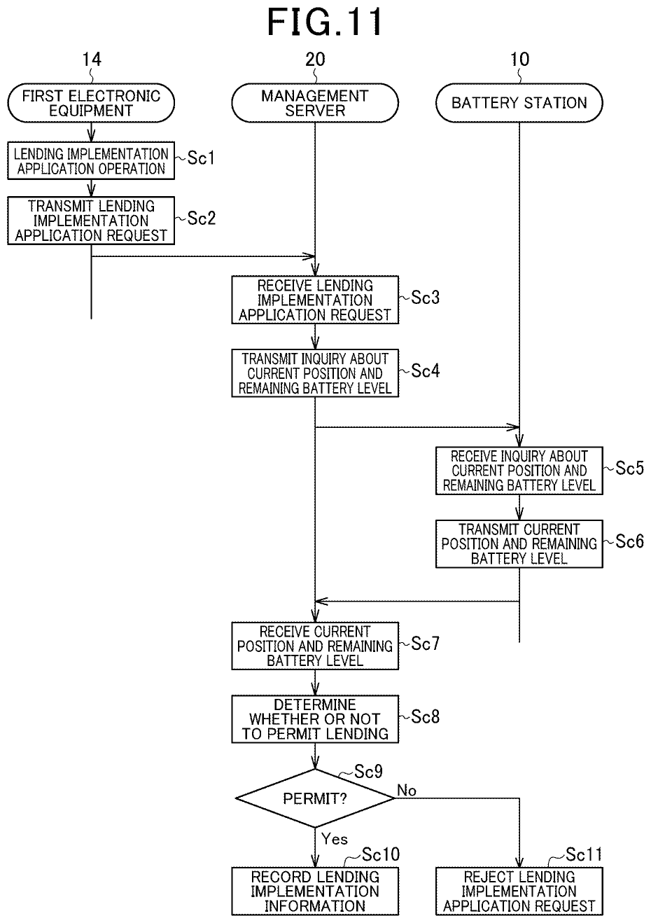

FIG. 11 is a view illustrating operation of the rental system 1 in a case where the lender 4 implements lending of the power pack 2.

In a case where the lender 4 lends the power pack 2, the lender 4 performs operation (lending implementation application operation) of applying for implementation of lending on the first electronic equipment 14.

As illustrated in FIG. 11, in a case where the lending implementation application operation is performed on the first electronic equipment 14 (step Sc1), the lending implementation application request unit 82 transmits the above-described lending implementation application request RA1 and each information of the lending implementation information JA to the management server 20 (step Sc2).

In a case where the management server 20 receives the lending implementation application request RA1 (step Sc3), the lending implementation permission unit 76 transmits a transmission message for inquiring about the current position and the remaining battery level to the battery station 10 (step Sc4). In a case where the battery station 10 receives the inquiry about the current position and the remaining battery level (step Sc5), the battery station 10 transmits the current position and the remaining battery level to the management server 20 (step Sc6).

Then, in a case where the management server 20 receives the current position of the battery station 10 and the remaining battery level (step Sc7), the lending implementation permission unit 76 determines whether or not to permit the lender 4 to implement lending on the basis of whether or not the predetermined conditions are satisfied (step Sc8: lending permission determination).

In the present embodiment, the predetermined permission conditions include the following first permission condition to fourth permission condition.

The first permission condition is that penalty of prohibition of implementation of lending is not imposed due to a fault of the lender 4 and is a condition for excluding the lender 4 who commits many faults.

The second permission condition is that it is determined that the moving body 8 is stopped on the basis of transition of the current position of the battery station 10 and is a condition for preventing a risk that the lending location applied for by the lender 4 is different from a location where lending is actually implemented by movement of the moving body 8 at that time.

The third permission condition is that a difference between the current position of the first electronic equipment 14 operated by the lender 4 and the current position of the battery station 10 is equal to or less than a predetermined value and is a condition for preventing a risk that the lending location applied for by the lender 4 is different from a location (location of the battery station 10) where lending is actually implemented by securing that the lender 4 performs lending implementation application operation near the battery station 10.

The fourth permission condition is that the remaining battery level of the power pack 2 is equal to or greater than a predetermined remaining battery level and is a condition for preventing lending of the power pack 2 for which a remaining battery level is insufficient.

In a case where all of the first permission condition to the fourth permission condition are satisfied, the lending implementation permission unit 76 determines to “permit” lending by the lender 4 (step Sc9: Yes), and the lending management unit 70 records the lending implementation information JA in the lending management table 77 (step Sc10).

By this means, implementation of lending applied for by the lender 4 is registered in the lending management table 77 and becomes a target for search by the borrower 6.

On the other hand, in a case where it is determined “not to permit” (step Sc9: No), the lending implementation permission unit 76 rejects the application for implementation of lending (step Sc11).

By this means, it is possible to exclude implementation of lending by the lender 4 with low evaluation by the borrower 6, that is, the lender 4 who commits many faults and reduce a situation where the borrower 6 suffers disadvantages due to a fault of the lender 4.

In addition to this, displacement between the lending location applied for by the lender 4 and an actual position of the battery station 10 can be prevented, so that it is possible to prevent a situation where the battery station 10 does not exist at the location when the borrower 6 goes to the lending location.

Further, it is possible to prevent lending of the power pack 2 with an insufficient remaining battery level, so that it is possible to prevent a situation where the borrower 6 cannot borrow the power pack 2 with a sufficient remaining battery level at the lending location.

According to the present embodiment, the following effects are provided.

The management server 20 of the present embodiment is a computer that manages lending and borrowing of the power pack 2 detachably provided in the moving body 8 between the lender 4 who lends the power pack 2 and the borrower 6 who borrows the power pack 2.

The management server 20 includes the lending management unit 70 configured to receive the lending location designated by the lender 4 from the first electronic equipment 14 and manage the lending location in association with the lender 4, and the borrowing permission granting unit 73 configured to, in a case where the borrowing permission request RA3 of the power pack 2 is received from the second electronic equipment 16, grant permission for borrowing to the borrower 6 by transmitting borrowing information necessary for borrowing of the power pack 2 at the lending location to the second electronic equipment 16. Further, the management server 20 includes the lender management unit 75 configured to, in a case where the borrower 6 who acquires permission for borrowing cannot borrow the power pack 2 at the lending location or in a case where the remaining battery level of the power pack 2 is equal to or less than a predetermined value, impose penalty on the lender 4 of the power pack 2.

According to this configuration, in a case where the borrower 6 cannot borrow the power pack 2 although the borrower 6 goes to the lending location or in a case where the remaining battery level of the power pack 2 is insufficient, penalty is imposed on the lender 4. This can sufficiently make the lender 4 pay attention regarding implementation of lending, reduce disadvantages to be suffered by the borrower 6 from the lender 4 and correct the disadvantages.

In the management server 20 of the present embodiment, the lending management unit 70 receives a time limit for limiting a period during which the borrower 6 can borrow the power pack 2 at the lending location from the first electronic equipment 14 operated by the lender 4 and manages the time limit in association with the lending location.

According to this configuration, when the time limit has elapsed, the lender 4 can move from the lending location regardless of whether or not there is the borrower 6, so that the lender 4 does not have to endlessly wait for the borrower 6 at the location.

In the present embodiment, the moving body 8 includes the battery station 10 that can detachably store the power pack 2. Further, the management server 20 includes the lending implementation permission unit 76 configured to, in a case where the lending implementation application request RA1 of the power pack 2 is received from the first electronic equipment 14 operated by the lender 4, permit implementation of lending in a case where it is determined that the moving body 8 is stopped on the basis of transition of the current position of the battery station 10.

According to this configuration, it is possible to prevent a risk that the lending location applied for by the lender 4 is different from a location where lending is actually implemented by movement of the moving body 8 at that time. This can prevent occurrence of a situation where the borrower 6 cannot find the battery station 10 when the borrower 6 goes to the lending location applied for by the lender 4.

In the management server 20 of the present embodiment, the lending implementation permission unit 76 permits implementation of lending in a case where a difference between the current position of the power pack 2 and the current position of the first electronic equipment 14 is equal to or less than a predetermined value.

According to this configuration, it is secured that the lender 4 applies for implementation of lending by operating the first electronic equipment 14 near the battery station 10. This can prevent a risk that the lending location applied for by the lender 4 is different from a location where lending is actually implemented (location of the battery station 10), so that it is possible to reliably prevent occurrence of a situation where the borrower 6 cannot find the battery station 10.

The management server 20 of the present embodiment includes the lender evaluation acquisition unit 74 configured to receive an evaluation result performed by the borrower 6 for the lender 4 from the second electronic equipment 16 and, in a case where the evaluation result is evaluation for the lender 4 corresponding to lending for which permission for borrowing is acquired, record the evaluation information JB3 based on the evaluation result in association with the lender 4.

According to this configuration, in a case where a situation occurs where the borrower 6 cannot borrow the power pack 2, the evaluation result based on occurrence of the situation can be registered in the management server 20. Further, in a case where the evaluation result is evaluation for the lender 4 corresponding to lending for which permission for borrowing is acquired, the evaluation information JB3 based on the evaluation result is recorded, so that it is possible to improve credibility of evaluation on the lender 4.

In the management server 20 of the present embodiment, the lender evaluation acquisition unit 74 records the evaluation information JB3 based on the evaluation result in association with the lender 4 in a case where a difference between the current position of the battery station 10 and the current position of the second electronic equipment 16 is equal to or less than a predetermined value.

According to this configuration, it is secured that the borrower 6 goes to the lending location and performs evaluation at the location, so that it is possible to exclude evaluation for the purpose of prank, abuse, or the like, and further improve credibility of evaluation on the lender 4.

In the management server 20 of the present embodiment, the lender management unit 75 imposes penalty of restricting implementation of lending of the power pack 2 in accordance with the evaluation information JB3.

According to this configuration, implementation of lending by the lender 4 with poor evaluation for implementation of lending (in the present embodiment, the lender 4 who commits a fault that makes the borrower 6 impossible to borrow the power pack 2) is restricted, so that it is possible to prevent the borrower 6 from suffering disadvantages from the lender 4 and correct disadvantages of the borrower 6.

Note that the above-described embodiment is merely an example of one aspect of the present invention, any modification and application can be made within a range not deviating from the gist of the present invention, and aspects related to the embodiment, modifications and applications can be arbitrarily combined.

### Modification 1

In the above-described embodiment, the management server 20 may improve credibility of evaluation as follows.

In other words, in the management server 20, the lender evaluation acquisition unit 74 receives the evaluation result performed by the borrower 6 for the lender 4 from the second electronic equipment 16, and in a case where the evaluation result is evaluation for the lender 4 corresponding to lending for which permission for borrowing is acquired, records the evaluation information JB3 based on the evaluation result by the borrower 6 in the lender management table 78 (FIG. 5) in association with the lender 4 in a case where a captured image of the display 32 (FIG. 2) that displays that lending is being implemented or a captured image of a state where the display 32 is hidden by an obstacle is received from the second electronic equipment 16. Note that the lender evaluation acquisition unit 74 recognizes a display state or a hidden state of the display 32 in the captured image received from the second electronic equipment 16 using a publicly known or well-known image recognition method.

According to the present modification, a proof of a situation at that time when the borrower 6 goes to the lending location is indicated in the captured image, so that it is possible to further improve credibility of evaluation.

### Modification 2

In the above-described embodiment, the management server 20 may determine the lending implementation application including a lending location designated as a lending location where it is difficult for the borrower 6 to borrow the power pack 2 as follows and may prevent lending implementation from being registered at the lending location.

In other words, the lender evaluation acquisition unit 74 tallies and manages evaluation for each lending location by recording evaluation results and lending locations in an appropriate table in association with each other.

Further, in a case where the lending implementation application request RA1 of the power pack 2 is received from the first electronic equipment 14 operated by the lender 4, the lending implementation permission unit 76 determines whether or not a location where it is difficult for the borrower 6 to borrow the power pack 2 is designated as the designated location by determining whether or not evaluation associated with the lending location designated by the lender 4 is favorable (for example, determining whether or not an evaluation value obtained by quantifying the evaluation is equal to or greater than a predetermined value).

Specifically, a location within a building, a structure or a premise that requires permission or unlocking operation for entry is a location where it is difficult for the borrower 6 to enter. In a case where lending is implemented while setting such a location as the lending location, a number of cases occur where the borrower 6 cannot borrow the power pack 2, and poor evaluations are registered for many lenders 4 who implement lending at the lending location, which results in associating a number of poor evaluations with the lending location. In other words, poorness of evaluation associated with the lending location correlate with a location where it is difficult for the borrower 6 to borrow the power pack 2. Thus, in a case where evaluation associated with the lending location is poor (for example, in a case where an evaluation value is less than a predetermined value), the lending implementation permission unit 76 prohibits implementation of lending at the lending location by rejecting the lending implementation application request RA1 without permitting implementation of lending.

According to the present modification, it is possible to prevent implementation of lending at a location where it is difficult for the borrower 6 to borrow the power pack 2, so that it is possible to improve user-friendliness of the borrower 6.

### Modification 3

In the above-described embodiment, the lending implementation permission unit 76 of the management server 20 permits implementation of lending on condition (fourth permission condition) that the remaining battery level of the power pack 2 is equal to or greater than a predetermined value.

However, in a case where the power pack 2 is being charged at the battery station 10, charging is highly likely to be complemented (the remaining battery level is highly likely to reach equal to or greater than the predetermined value) by the time the borrower 6 goes to the lending location, and thus, the lending implementation permission unit 76 may grant permission regardless of the remaining battery level of the power pack 2.

However, in a case where a search request for lending locations (predetermined search condition) existing around the current position (which may be designated by the borrower 6) of the second electronic equipment 16 is received, the search execution unit 72 of the management server 20 transmits to the second electronic equipment 16, a search result obtained by excluding a lending location corresponding to the power pack 2 for which charging is not completed by the time the borrower 6 goes to the lending location from lending locations corresponding to lending of the power packs 2 that are being charged.

Specifically, the search execution unit 72 transmits a transmission message for inquiring about a period (charging completion period) required for the remaining battery level of the power pack 2 that is being charged to reach equal to or greater than the predetermined value, to the battery station 10. In a case where the battery station 10 receives the inquiry, the control device 40 predicts the charging completion period on the basis of a search result of the remaining battery level detector 42A of the charging device 42 and transmits the predicted charging completion period to the management server 20. Note that any publicly known or well-known method can be used as a method for predicting the charging completion period.

Further, the search execution unit 72 obtains a period required for the borrower 6 to arrive on the basis of distances (distances along roads) from respective lending locations that match the search condition to the current position of the second electronic equipment 16 and movement speed of the second electronic equipment 16 for each lending location. As the movement speed of the second electronic equipment 16, a fixed value determined in advance in accordance with a type, and the like, of the electric vehicle 24, legal speed of a road to the lending location, or the like, can be used.

Further, the search execution unit 72 specifies the power pack 2 for which charging is not completed by the time the borrower 6 goes to the lending location by specifying the power pack 2 for which the charging completion period exceeds the period required for the borrower 6 to arrive.

According to the present modification, a lending location corresponding to the power pack 2 for which charging is not completed by the time the borrower 6 goes to the lending location is not presented to the borrower 6, so that it is possible to prevent the borrower 6 from going to the lending location of the power pack 2 with an insufficient remaining battery level.

Note that in the present modification, the search execution unit 72 may transmit to the second electronic equipment 16, a search result including the charging completion period at the lending location instead of excluding the lending location corresponding to the power pack 2 for which charging is not completed by the time the borrower 6 goes to the lending location from the search result and may present the charging completion period to the borrower 6 through display on the second electronic equipment 16.

### Modification 4

In the above-described embodiment, in a case where restriction of implementation of lending is imposed on the lender 4 as penalty, the management server 20 may cancel implementation of lending that has been already permitted for the lender 4.

Specifically, in the management server 20, in a case where the lender management unit 75 imposes restriction of implementation of lending on the lender 4 as penalty, the lending management unit 70 deletes the lending implementation information JA associated with the lender 4 from the lending management table 77 or records information indicating cancellation of implementation of lending and indicating exclusion from a search target.

According to the present modification, it is possible to prevent implementation of lending that has been already permitted for the lender 4 on whom restriction of implementation of lending is imposed from being presented to the borrower 6 and prevent lending by the lender 4.

### Other Modifications

In the above-described embodiment, the power pack 2 may include the first communication device 46 that is included in the battery station 10, and the power pack 2 may perform communication with the management server 20. Further, the first electronic equipment 14 and the second electronic equipment 16 may perform communication with the management server 20 by way of the battery station 10.

In the above-described embodiment, the management server 20 may be configured to accept reservation of borrowing of the power pack 2 at a desired lending location by the borrower 6 from the second electronic equipment 16 of the borrower 6. In this case, the management server 20 may be configured to allow the lender 4 to grasp the reservation by transmitting information on the reservation to the first electronic equipment 14 of the lender 4.

The views illustrating functional configurations are schematic views illustrating components of the respective devices which are classified in accordance with main processing content to facilitate understanding of the present invention, and the components may be classified into more components in accordance with the processing content. Further, the components may be classified so that one component executes more kinds of processing.

### (Configurations Supported by Disclosure of the Present Specification)

Disclosure of the present specification supports the following configurations.

### Configuration 1

A management server that manages lending and borrowing of a battery between a lender who lends the battery and a borrower who borrows the battery, the battery being detachably provided in a moving body, the management server including: a lending management unit configured to receive a lending location designated by the lender as a location where lending of the battery is implemented from first electronic equipment operated by the lender and record the lending location in association with the lender; a borrowing permission granting unit configured to, in a case where a request for borrowing of the battery is received from second electronic equipment operated by the borrower, grant permission for borrowing to the borrower by transmitting information necessary for borrowing of the battery at the lending location to the second electronic equipment; and a lender management unit configured to, in a case where the borrower who acquires the permission for borrowing cannot borrow the battery at the lending location or in a case where a remaining battery level of the battery is equal to or less than a predetermined value, impose penalty on the lender of the battery.

According to the management server of configuration 1, it is possible to correct disadvantages that can be suffered by the borrower.

### Configuration 2

The management server according to configuration 1, in which the lending management unit receives a time limit that restricts a period during which the borrower can borrow the battery at the lending location from the first electronic equipment operated by the lender and manages the time limit in association with the lending location.

According to the management server of configuration 2, user-friendliness of the lender is improved.

### Configuration 3

The management server according to configuration 1 or 2, in which a battery station that detachably stores the battery is provided in the moving body, and the management server further includes a lending implementation permission unit configured to, in a case where an application for implementation of lending of the battery is received from the first electronic equipment operated by the lender, permit the implementation of lending in a case where it is determined that the moving body is stopped on the basis of transition of a current position of the battery station.

According to the management server of configuration 3, it is possible to prevent displacement between the lending location designated by the lender and a location where lending is actually implemented.

### Configuration 4

The management server according to configuration 3, in which the lending implementation permission unit permits the implementation of lending in a case where a difference between the current position of the battery station and a current position of the first electronic equipment is equal to or less than a predetermined value.

According to the management server of configuration 4, it is possible to more reliably prevent displacement between the lending location designated by the lender and a location where lending is actually implemented.

### Configuration 5

The management server according to configuration 3 or 4, in which the lending implementation permission unit receives a remaining battery level of the battery stored in the battery station from the battery station and permits the implementation of lending in a case where the remaining battery level is equal to or greater than a predetermined value.

According to the management server of configuration 5, it is possible to prevent implementation of lending of a battery with an insufficient remaining battery level.

### Configuration 6

The management server according to any of configuration 1 to configuration 4, further including a search execution unit configured to, in a case where a search condition is received from the second electronic equipment operated by the borrower, transmit the lending location that matches the search condition to the second electronic equipment, in which the search execution unit transmits, to the second electronic equipment, lending locations obtained by excluding, from lending locations that match the search condition, a lending location among lending locations corresponding to lending of batteries that are being charged, the lending location corresponding to lending of a battery with a remaining battery level that does not reach equal to or greater than the predetermined value by a time the second electronic equipment arrives at the lending location.

According to the management server of configuration 6, it is possible to prevent the borrower from going to a lending location of a battery with an insufficient remaining battery level.

### Configuration 7

The management server according to configuration 1 or 2, further including a lender evaluation acquisition unit configured to receive an evaluation result performed by the borrower for the lender from the second electronic equipment, and in a case where the evaluation result is evaluation on the lender corresponding to lending for which the permission for borrowing is acquired, record evaluation information based on the evaluation result in association with the lender.

According to the management server of configuration 7, it is possible to allow the borrower to evaluate the lender and improve credibility of evaluation.

### Configuration 8

The management server according to configuration 7, in which a battery station that detachably stores the battery is provided in the moving body, and the lender evaluation acquisition unit records the evaluation information based on the evaluation result in association with the lender in a case where a difference between a current position of the battery station and a current position of the second electronic equipment is equal to or less than a predetermined value.

According to the management server of configuration 8, it is possible to further improve credibility of evaluation.

### Configuration 9

The management server according to configuration 7 or 8, in which a battery station that detachably stores the battery is provided in the moving body, a display that indicates whether or not lending of the battery is being implemented is provided in the battery station, and the lender evaluation acquisition unit records the evaluation information based on the evaluation result in association with the lender in a case where a captured image of the display that displays that the lending is being implemented or a captured image of a state where the display is hidden by an obstacle is received from the second electronic equipment.

According to the management server of configuration 9, it is possible to further improve credibility of evaluation.

### Configuration 10

The management server according to any one of configurations 7 to 9, in which the lender management unit imposes penalty of restricting implementation of lending of the battery in accordance with the evaluation information.

According to the management server of configuration 10, implementation of lending by the lender is restricted in accordance with evaluation, so that it is possible to prevent occurrence of a situation where the borrower suffers disadvantages by the lender with poor evaluation.

### Configuration 11

The management server according to any of configurations 7 to 10, in which the lender evaluation acquisition unit records a lending location and the evaluation result in association with each other, and the management server further includes a lending implementation permission unit configured to, in a case where an application for implementation of lending of the battery is received from the first electronic equipment operated by the lender, permit the implementation of lending on the basis of the evaluation result corresponding to the lending location designated by the lender.

According to the management server of configuration 11, it is possible to prevent lending at a location where it is difficult for the borrower to borrow the battery.

### Configuration 12

A control method of a management server that manages lending and borrowing of a battery between a lender who lends the battery and a borrower who borrows the battery, the battery being detachably provided in a moving body, the control method including a step of receiving a lending location designated by the lender as a location where lending of the battery is implemented from first electronic equipment operated by the lender and recording the lending location in association with the lender, a step of, in a case where a request for borrowing of the battery is received from second electronic equipment operated by the borrower, granting permission for borrowing to the borrower by transmitting information necessary for borrowing of the battery at the lending location to the second electronic equipment, and a step of, in a case where the borrower who acquires the permission for borrowing cannot borrow the battery at the lending location or in a case where a remaining battery level of the battery is equal to or less than a predetermined value, imposing penalty on the lender of the battery.

According to the control method of the management server of configuration 12, it is possible to correct disadvantages to be suffered by the borrower.

### REFERENCE SIGNS LIST

1 rental system
2 power pack (battery)
4 lender
6 borrower
8 moving body
10 battery station
14 first electronic equipment
16 second electronic equipment
17 app
20 management server
70 lending management unit
72 search execution unit
73 borrowing permission granting unit
74 lender evaluation acquisition unit
75 lender management unit
76 lending implementation permission unit

What is claimed is:

1. A management server that manages lending and borrowing of a battery between a lender who lends the battery and a borrower who borrows the battery, the battery being detachably provided in a moving body, the management server comprising:
a lending management unit configured to receive a lending location designated by the lender as a location where lending of the battery is implemented from first electronic equipment operated by the lender and record the lending location in association with the lender;
a borrowing permission granting unit configured to, in a case where a request for borrowing of the battery is received from second electronic equipment operated by the borrower, grant permission for borrowing to the borrower by transmitting information necessary for borrowing of the battery at the lending location to the second electronic equipment; and
a lender management unit configured to, in a case where the borrower who acquires the permission for borrowing cannot borrow the battery at the lending location or in a case where a remaining battery level of the battery is equal to or less than a predetermined value, impose penalty on the lender of the battery.

2. The management server according to claim 1,
wherein the lending management unit receives a time limit that restricts a period during which the borrower can borrow the battery at the lending location from the first electronic equipment operated by the lender and manages the time limit in association with the lending location.

3. The management server according to claim 1,
wherein a battery station that detachably stores the battery is provided in the moving body, and
the management server further comprises a lending implementation permission unit configured to, in a case where an application for implementation of lending of the battery is received from the first electronic equipment operated by the lender, permit the implementation of lending in a case where it is determined that the moving body is stopped on a basis of transition of a current position of the battery station.

4. The management server according to claim 3,
wherein the lending implementation permission unit permits the implementation of lending in a case where a difference between the current position of the battery station and a current position of the first electronic equipment is equal to or less than a predetermined value.

5. The management server according to claim 3,
wherein the lending implementation permission unit receives a remaining battery level of the battery stored in the battery station from the battery station and permits the implementation of lending in a case where the remaining battery level is equal to or greater than a predetermined value.

6. The management server according to claim 1, further comprising:
a search execution unit configured to, in a case where a search condition is received from the second electronic equipment operated by the borrower, transmit the lending location that matches the search condition to the second electronic equipment,
wherein the search execution unit transmits, to the second electronic equipment, lending locations obtained by excluding, from lending locations that match the search condition, a lending location among lending locations corresponding to lending of batteries that are being charged, the lending location corresponding to lending of a battery with a remaining battery level that does not reach equal to or greater than the predetermined value by a time the second electronic equipment arrives at the lending location.

7. The management server according to claim 1, further comprising:
a lender evaluation acquisition unit configured to receive an evaluation result performed by the borrower for the lender from the second electronic equipment, and in a case where the evaluation result is evaluation on the lender corresponding to lending for which the permission for borrowing is acquired, record evaluation information based on the evaluation result in association with the lender.

8. The management server according to claim 7,
wherein a battery station that detachably stores the battery is provided in the moving body, and
the lender evaluation acquisition unit records the evaluation information based on the evaluation result in association with the lender in a case where a difference between a current position of the battery station and a current position of the second electronic equipment is equal to or less than a predetermined value.

9. The management server according to claim 7,
wherein a battery station that detachably stores the battery is provided in the moving body,
a display that indicates whether or not lending of the battery is being implemented is provided in the battery station, and
the lender evaluation acquisition unit records the evaluation information based on the evaluation result in association with the lender in a case where a captured image of the display that displays that the lending is being implemented or a captured image of a state where the display is hidden by an obstacle is received from the second electronic equipment.

10. The management server according to claim 7,
wherein the lender management unit imposes penalty of restricting implementation of lending of the battery in accordance with the evaluation information.

11. The management server according to claim 7,
wherein the lender evaluation acquisition unit records a lending location and the evaluation result in association with each other, and
the management server further comprises a lending implementation permission unit configured to, in a case where an application for implementation of lending of the battery is received from the first electronic equipment operated by the lender, permit the implementation of lending on a basis of the evaluation result corresponding to the lending location designated by the lender.

12. A control method of a management server that manages lending and borrowing of a battery between a lender who lends the battery and a borrower who borrows the battery, the battery being detachably provided in a moving body, the control method comprising:
a step of receiving a lending location designated by the lender as a location where lending of the battery is implemented from first electronic equipment operated by the lender and recording the lending location in association with the lender;
a step of, in a case where a request for borrowing of the battery is received from second electronic equipment operated by the borrower, granting permission for borrowing to the borrower by transmitting information necessary for borrowing of the battery at the lending location to the second electronic equipment; and
a step of, in a case where the borrower who acquires the permission for borrowing cannot borrow the battery at the lending location or in a case where a remaining battery level of the battery is equal to or less than a predetermined value, imposing penalty on the lender of the battery.
